(19) United States
(12) Patent Application Publication
(10) Pub. No.: US 2005/0268509 A1
(43) Pub. Date: Dec. 8, 2005

(54) Vehicle locator and identification card

(76) Inventor: Mark W. Lewis, Greenville, SC (US)

Correspondence Address: John B. Hardaway, III;NEXSEN PRUET, LLC, P.O. Box 10107, Greenville, SC, 29603, US

(21) Appl. No.: 10/860,459

(22) Filed: Jun. 3, 2004

(51) Int. Cl. G09F 3/14

(52) U.S. Cl. 40/664

(57) ABSTRACT

A vehicle locator and identification card for vehicle parking and servicing establishments includes a sheet of paperboard having the identical number printed on three different segments defined by perforations or partial die cuts. A patch of clear plastic is laminated to one segment of the paperboard sheet from which a key ring is die punched. The other segments are a customer claim check and a tag for placement in a parked or serviced vehicle.

### BACKGROUND OF THE INVENTION

Businesses concerned with parking or servicing vehicles have a problem of correlating the ignition key and the vehicle owner with a particular vehicle. Paper cards with three segments separated by perforations and carrying the same number have been provided so that one segment serves as a claim check, a second segment is placed in the vehicle and a third segment has a key ring stapled to it. A computer type multiple copy form with perforated tear-off strips has been proposed for correlation of ignition key, vehicle and customer which includes perforation lines permitting separation of the form into sections—one to be placed on the vehicle, one to be connected to the ignition key in some undisclosed manner and one to be given to the automobile owner as a claim check.

### BRIEF DESCRIPTION OF THE INVENTION

An automotive vehicle locator card is formed from a thick sheet of pliable paperboard material with the same number printed on three segments of the card. The numbers and other printing are also printed on the reverse side of the card. The three segments are established by perforations or slits which permit the segments to be easily separated from one another. A large upper segment of the card includes a punched out hole and a slit from an edge of the card to the hole which permits the upper segment to be attached to the rear view mirror bracket of the vehicle. A second segment of the card is a customer's claim check. A third segment of the card is at least partially laminated by a patch sheet of strong pliable material, such as plastic. A removable key ring is defined by perforations or cuts in the laminated area of the third segment of the card and includes a head connected to a tail by a narrow intermediate shank. The head is inserted into a hole in the tail to form a ring for holding an ignition key.

### BRIEF DESCRIPTION OF THE DRAWINGS

An embodiment of the invention is shown in the accompanying drawings in which:

FIG. 1 shows a vehicle locator and identification card;

FIG. 2 is an enlarged section taken on line 2-2 in FIG. 1;

FIG. 3 is a view similar to FIG. 2 but showing the key ring separated from the card;

FIG. 4 shows the key ring attached to an ignition key and hung on a support peg; and

FIG. 5 illustrates prior art.

### DETAILED DESCRIPTION OF THE INVENTION

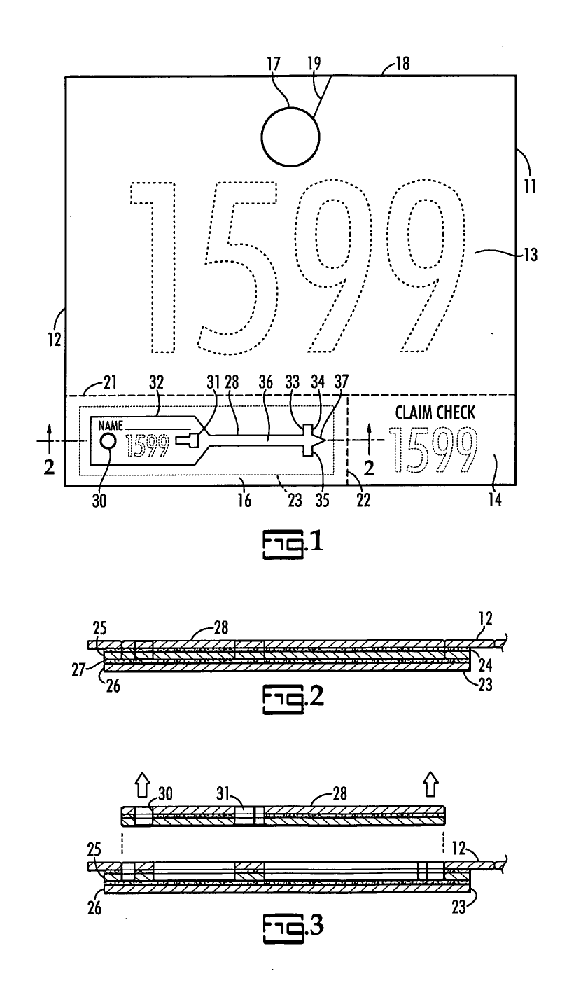

The automotive vehicle locator card 11 shown in FIG. 1 includes a relatively thick pliable paperboard sheet 12 on which the same identification indicia in the form of numbers, such as 1599, is printed on both sides of three different segments 13, 14, 16. The top segment 13 with a large number 1599 has an annular hole or opening 17 formed near its top edge 18 and the paperboard sheet 12 is cut through to form a slot 19 between the hole 17 and the top edge 18. The paperboard sheet 12 is perforated by cuts, or die cut substantially through its thickness, along lines 21, 22 thereby defining and permitting easy separation of the three segments 13, 14, 16.

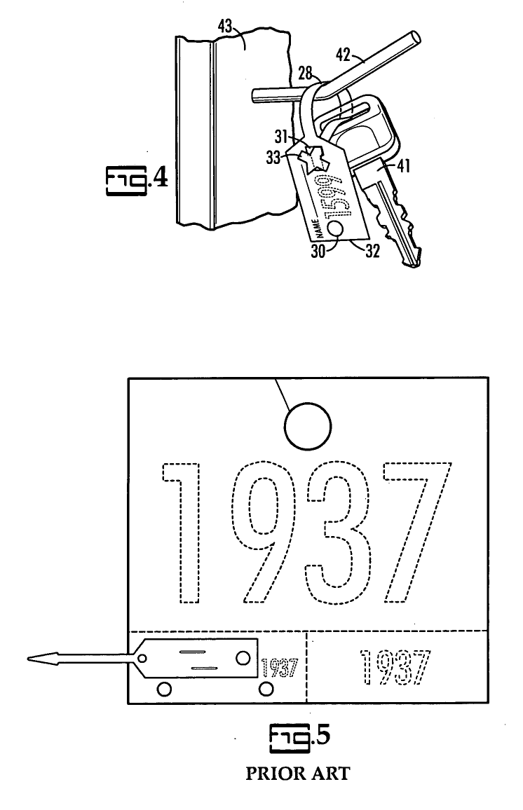

As shown in FIGS. 2 and 3 a patch 23 is bonded to the underside of the paperboard sheet 12 by a suitable layer of permanent adhesive 24. The patch 23 includes an upper clear plastic layer 25 and a lower plastic layer 26 which are bonded together by a suitable lamina release agent 27. The lamina-release agent may be composed of clear polyurethane, acrylic urethane or other substances which can be cured from liquid to solid in the manner of clear polyurethane. After the patch 23 is bonded to the paperboard 12, an arrow shaped key ring 28 is formed by die cutting through the paperboard 12 and the clear plastic lamina 25 but not through the bottom plastic layer 26. An annular hole 30 and a T shaped hole 31 are also die cut through the lamina layers 12 and 25 in a tail 32 of the arrow shaped key ring 28. The word NAME and a blank space are provided on the tail 32 for entry of the customer's or vehicle owner's name. The head 33 of the arrow shaped key ring 28 has a pair of ears 34, 35 extending radially outwardly from the front end of the shank 36 and a pointed nose 37. The width of the shank 34 is approximately the same as the lateral width of the widest part of the T shaped hole 31.

FIG. 3 shows the key ring 28 removed from the paperboard 12 and the clear lamina plastic layer 26. When a vehicle is brought to a parking or vehicle servicing establishment, the card 11 of FIG. 1 is easily separated manually on perforation lines 21, 22 to provide a separate vehicle mounting segment 13, which is easily placed on the support bracket of the rear view mirror of the vehicle. The customer claim check segment 14, is separated and given to the customer and a segment in the form of the arrow shaped key ring 28 is secured to the vehicle ignition key 41, as shown in FIG. 4, by forcing the arrow head 33 through the T shaped hole 31 in the tail 32 of the arrow shaped key ring 28. FIG. 4 shows the key ring 28 placed on a peg 42 on a vertical wall 43 of the parking or servicing establishment. The key ring 28 may also be placed on the peg 42 by using the hole 30.

The vehicle locator card 11 with its three segments carrying the same identification indicia on both sides and easily separated into segments for placement in the vehicle, for a claim check and for a key ring, helps parking and servicing establishments provide prompt and accurate customer service. The pliable plastic layer or lamina 25 gives the key ring 28 the proper strength to retain the ignition key 41 and to maintain the arrow head 33 in the hole 31. The key ring 28 is easily removed from the card 11 by bending the card 11.

Referring to the prior art device of FIG. 5, a separately procured arrow shaped key ring is manually stapled to the lower left hand segment of a service tag. The arrow is passed through the usual opening in the ignition key and through a hole near the end of the shank of the arrow. Then the segment and key ring may be hung on a peg using one of the two holes in the segment of the card to which the key ring is attached.

1. A vehicle locator card comprising:
a sheet of relatively thin pliable paperboard having lines of perforations defining three segments, each having the same identification indicia printed thereon, said perforations permitting easy separation of said segments from one another,
a thin patch of clear plastic laminated to part of one of said segments, and
an arrow shaped key ring formed by die cutting through said sheet of paperboard and said clear plastic of said one segment, said arrow shaped key ring having a head, a shank and a tail, said tail having an opening for receiving said head in a releasably secured manner.

2. A vehicle locator card comprising:
a sheet of pliable paperboard,
a patch of clear pliable plastic over a predetermined area of said paperboard sheet,
cuts in said card dividing said card into a first segment adapted for placement in a vehicle, a second segment serving as a claim check, and a third segment within said area covered by said patch of clear plastic forming an arrow shaped key ring having a head, a shank and a tail having a hole for releasably receiving said head of said key ring, and
each of said segments carrying identical identification indicia.

3. A vehicle locator and identification card comprising:
a sheet of relatively thick paperboard,
a patch having two clear plastic layers bonded to one another, one of which is bonded to a predetermined area of said paperboard, and
cuts in said paperboard and in one of said layers of plastic forming removable segments including a first segment adapted for a placement in a vehicle, a second segment serving as a claim check and a third segment serving as a key ring, said key ring being formed from said predetermined area whereby it is covered on one side by one of said plastic layers, each of each segments carrying the same identification indicia.

4. The vehicle locator and identification card of claim 3 wherein said plastic layers are bonded together by a lamina-release agent.
